(19) United States
(12) Patent Application Publication
(10) Pub. No.: US 2020/0109303 A1
(43) Pub. Date: Apr. 9, 2020

(54) Print Material Formulation for Droplet Inspection

(71) Applicant: Kateeva, Inc., Newark, CA (US)

(72) Inventors: Teresa A. Ramos, San Jose, CA (US); Siddharth Harikrishna-Mohan, Chicago, IL (US); Michael Morse, San Jose, CA (US); Conor F. Madigan, San Francisco, CA (US); Christopher D. Favaro, Fremont, CA (US)

(73) Assignee: Kateeva, Inc., Newark, CA (US)

(21) Appl. No.: 16/545,792

(22) Filed: Aug. 20, 2019

Related U.S. Application Data
(60) Provisional application No. 62/743,361, filed on Oct. 9, 2018.
(60) Provisional application No. 62/852,713, filed on May 24, 2019.

(51) Int. Cl. C09D 11/38; C08K 3/08; C08K 3/22; B41J 2/04

(52) U.S. Cl. CPC C09D 11/38; C08K 3/08; C08K 3/22; B82Y 15/00; C08K 2003/0806; C08K 2003/2241; C08K 2201/011; B41J 2/04

(57) ABSTRACT

Embodiments described herein provide a print material, comprising a curable precursor mixture; and a plurality of light-scattering particles, wherein a droplet of the print material having diameter of about 30 μm has a maximum transmission haze at a wavelength less than about 500 nm and a transmission haze at an infrared wavelength up to about 1,600 nm that is less than 60% of the maximum transmission haze. In some cases, a polymer film having thickness of about 20 μm made from a print material has a maximum transmission haze at a wavelength less than about 500 nm and a transmission haze at an infrared wavelength up to about 1,600 nm that is less than 60% of the maximum transmission haze. A process is also described, including applying the material above to a substrate as a print material and solidifying the print material to form a structure on the substrate.

### CROSS-REFERENCE TO RELATED APPLICATIONS

This patent application claims benefit of U.S. Provisional Patent Application Ser. No. 62/743,361 filed Oct. 9, 2018, and U.S. Provisional Patent Application Ser. No. 62/852,713 filed May 24, 2019, each of which is incorporated herein by reference.

### FIELD

Embodiments of the present invention generally relate to inkjet printers. Specifically, methods and apparatus for monitoring and control of print materials during deposition processes are disclosed.

### BACKGROUND

Inkjet printing is common, both in office and home printers and in industrial scale printers used for fabricating displays, printing large scale written materials, adding material to manufactured articles such as PCB's, and constructing biological articles such as tissues. Most commercial and industrial inkjet printers, and some consumer printers, use piezoelectric dispensers to apply print material to a substrate. A piezoelectric material is arranged adjacent to a print material reservoir. Applying a voltage to the piezoelectric material causes it to deform in a way that applies a compressive force to the print material reservoir, which is constructed in turn to eject print material when the compressive force is applied.

Some inkjet printing applications rely on extreme precision in positioning of print nozzles, quantity and type of print material ejected, and velocity and trajectory of droplet ejection. When nozzles fail to eject print material on demand, with the correct volume, velocity, and trajectory, printing faults result and time and money must be spent correcting the faults. Optical systems are routinely used to monitor droplet size and flight from print nozzles to substrates. Such systems typically rely on light scattered from droplets of print material to determine droplet characteristics. However, in some cases, the droplets themselves contain materials with certain light-scattering properties that can complicate optical droplet measurement. Thus, there is a need for print material formulations and droplet measurement techniques and systems that are complimentary.

### SUMMARY

Embodiments described herein provide a print material, comprising a curable precursor mixture; and a plurality of light-scattering particles, wherein a droplet of the print material having diameter of about 30 μm has a maximum transmission haze at a wavelength less than about 500 nm and a transmission haze at an infrared wavelength up to about 1,600 nm that is less than 60% of the maximum transmission haze.

Other embodiments described herein provide a print material, comprising a curable precursor mixture; and a plurality of light-scattering particles, wherein a polymer film of thickness about 20 μm formed from the print material has a maximum transmission haze at a wavelength less than about 500 nm and a transmission haze at an infrared wavelength up to about 1,600 nm that is less than 60% of the maximum transmission haze.

Other embodiments described herein provide a method of making a device, comprising applying a print material to a substrate, the print material comprising a curable precursor mixture; one or more quantum dots; and a plurality of light-scattering particles, wherein a droplet of the print material having a diameter of about 30 μm has a maximum transmission haze at a wavelength less than about 500 nm and a transmission haze at an infrared wavelength up to about 1,600 nm that is less than about 60% of the maximum transmission haze; and solidifying the print material to form a structure on the substrate.

Other embodiments described herein provide a device having a component comprising a vinylic polymer; and a plurality of light-scattering particles dispersed in the polymer, wherein a film of the polymer containing the dispersed light-scattering particles and having a thickness of about 20 μm has a maximum transmission haze at a wavelength less than about 500 nm and a transmission haze at an infrared wavelength up to about 1,600 nm that is less than about 60% of the maximum transmission haze.

Other embodiments described herein provide an inkjet printer, comprising a print assembly juxtaposed with a substrate support; and a diagnostic module coupled to the print assembly or the substrate support, the diagnostic module comprising an infrared laser operating at a wavelength of 850 nm to 1,600 nm.

Other embodiments described herein provide a method of making a device, comprising applying a print material to a substrate, the print material comprising a curable precursor mixture; one or more quantum dots; and a plurality of light-scattering particles, wherein a polymer film formed from the print material to a thickness of about 20 μm has a maximum transmission haze at a wavelength less than about 500 nm and a transmission haze at an infrared wavelength up to about 1,600 nm that is less than about 60% of the maximum transmission haze; and solidifying the print material to form a structure on the substrate.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope.

FIG. 1 is a side view of a device according to one embodiment.

FIG. 2A is an isometric top view of a print apparatus 200 according to one embodiment.

FIG. 2B is a detailed view of a diagnostic module of the print apparatus of FIG. 2A according to one embodiment

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Print materials that compliment droplet measurement systems generally do not scatter light in wavelengths used to perform droplet measurement. Some such print materials include optical components for light generation, light frequency conversion, and light-scattering. The print materials disclosed herein have formulations for light conversion and scattering that minimize scattering and conversion of light in wavelengths usable for droplet measurement.

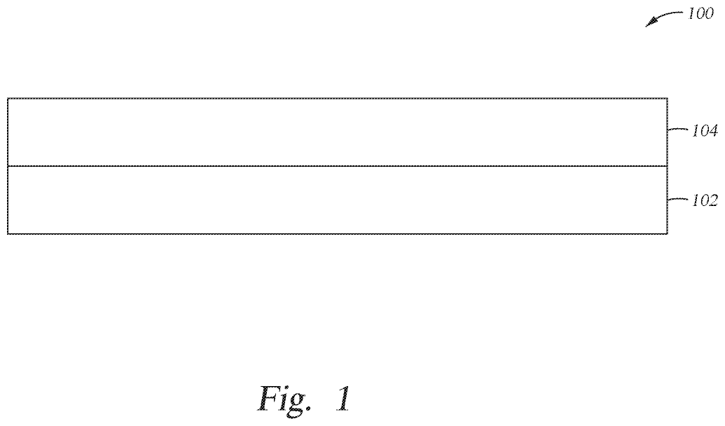

FIG. 1 is a side view of a device 100 according to one embodiment. The device 100 is a light-emitting device that may be used as a display device or another light-emitting device. The device 100 generally has a light emitting component 102 and a light conditioning component 104. Here, the two components are depicted as layers, but they may have any convenient shape. The light emitting component 102 generally emits light at visible wavelengths between about 400 nm and about 500 nm. The light conditioning component 104 is a composite material with a polymeric matrix that contains various functional additives. The polymeric matrix is generally transmissive to the light emitted by the light emitting component 102. The additives can include particles, such as quantum dots, that absorb the light emitted by the light emitting component 102 as activating energy and emit light at another frequency upon decaying to the ground state. In this way, the light conditioning component 104 can be a frequency conversion component that converts the frequency of the light from that emitted by the light emitting component 102 to another frequency.

Additionally, or instead, the additives in the light conditioning component 104 can include light-scattering particles. The light-scattering particles can increase absorption of light by the quantum dots in frequency conversion components by increasing lateral trajectory of photons incident on the light conditioning component 104. The light-scattering particles can also produce a targeted amount of dispersion in light transmitted through the light conditioning component 104 when no frequency conversion components are present. In this way, the light conditioning component 104 can be a light channeling component.

The light-scattering particles in some cases are particles that impart a peak scattering, when dispersed in a polymer as described herein, at electromagnetic wavelengths less than about 500 nm. For the purposes of this application, relevant wavelengths for scattering and haze are less than about 11 μm. For reasons further described below, the light-scattering particles also provide scattering in the polymer at infrared wavelengths up to about 2,500 nm that is less than about 60% of the peak scattering. Scattering at wavelengths less than about 500 nm indicates that the light-scattering particles are at least somewhat effective in scattering the 400-500 nm light emitted by the light emitting component 102. Scattered radiation here refers to all radiation that is scattered at any angle in a static light-scattering analysis.

Scattered radiation is determined by directing a photon field having known cross-sectional area (area in a plane perpendicular to the propagation direction) and incident intensity through a medium, ascertaining the radiation intensity emerging from the medium that is within the cross-sectional area a short distance from the medium, and subtracting the ascertained intensity from the initial intensity. Radiation intensity refers to radiant power flux or radiant power transmitted through a unit area. Dependence of scattered intensity on wavelength can be determined by directing photons of different wavelengths, for example a spectrum, through the medium and measuring the scattered radiant intensity for each wavelength.

For these materials, the ratio of scattered radiation intensity to incident radiation intensity can be plotted as a function of wavelength and the plot will have a maximum, representing peak scattering, at a wavelength less than about 500 nm. In some cases, the plot will never be more than about 60% of the maximum value at any infrared wavelength up to about 2,500 nm, for example between about 800 nm and about 2,500 nm. In other cases, the plot may momentarily rise above 60% of the maximum value at infrared wavelengths up to about 2,500 nm, for example between about 800 nm and about 2,500 nm, but an average value of the plot in such wavelength range will be less than 60% of the maximum value. Such an average can be defined in some cases as

$${S}_{avg} = \frac{{\int }_{{w}_{1}}^{{w}_{2}} S ( w ) dw}{{w}_{2} - {w}_{1}} ,$$

where S(w) is the wavelength-dependent scattering, w is wavelength, and w₁ and w₂ define the wavelength range. In some cases, the material has peak scattering, when dispersed in a polymer as described herein, at electromagnetic wavelengths less than about 500 nm, and scattering at infrared wavelengths up to about 2,500 nm that is less than about 20%, or 10%, or 5%, or 1% of the peak scattering.

In other cases, the light-scattering particles, when dispersed in a polymer matrix as described above, impart scattering in the form of transmission haze that is at a maximum at wavelengths less than about 500 nm, and declines with increasing wavelength such that the transmission haze, at an infrared wavelength less than about 1,600 nm, is no more than 60% of the maximum transmission haze. Such parameters may be measured by forming a polymer film containing the dispersed light-scattering particles to a thickness of about 20 μm and measuring transmission haze of the polymer film using, for example, ASTM method D1003. As above, the transmission haze at infrared wavelengths up to about 1,600 nm can be 60% or less, 30% or less, 20% or less, 10% or less, 5% or less, or 1% or less of the maximum transmission haze. The transmission haze can be plotted as a function of wavelength to view the decline with increasing wavelength. As noted above, for the purposes of this technology, relevant wavelengths for haze and scattering analysis are less than about 11 μm.

Materials that can be used for the light-scattering particles include silver nanoparticles of dimension less than about 150 nm, such as 30-150 nm, for example 50 nm. The silver nanoparticles may have a thin oxide coating less than 30 nm thick, for example 2 to 25 nm thick. The nanoparticles may be nanospheres, nanorods, or other geometric shapes or facsimiles thereof. Other materials that can be used include ceramics and/or metal oxides such as TiO₂, ZrO₂, and HfO₂ potentially coated with other materials such as Al₂O₃. Nanoparticles of ceramic or metal oxide materials generally in the particle size range of about 100 nm to about 250 nm, such as about 140 nm to 250 nm, for example between about 165 nm and about 190 nm, for example about 170 nm.

Particle size range of ceramic particles or metal oxide particles useable as light-scattering particles for the light conditioning component 104 can be characterized by dynamic light-scattering, for example using ASTM methods B822, D4464, or D523. For the case of ceramic particles, the collection of particles has particle size of about 100 nm to about 250 nm, such as about 130 nm to about 230 nm, for example 190 nm. For the case of silver nanoparticles, the particle size range is from about 30 nm to about 150 nm, such as about 40 nm to about 70 nm, for example 50 nm.

The light-scattering particles have a distribution of sizes in the ranges given above. Smaller particles scatter shorter wavelengths more effectively and larger particles scatter longer wavelengths more effectively. Here, the median particle, having the median size, within any of the ranges given above, scatters light within the polymers described herein at short wavelengths more than at long wavelengths. The median particle has peak scattering, within the polymers described herein, at a wavelength less than about 500 nm and scattering of infrared light up to a wavelength of about 2,500 nm that is less than 60% of the peak. Alternately, or additionally, the median particle imparts transmission haze to a polymer film containing a dispersion of the particles and having a thickness of about 20 μm that is maximum at a wavelength less than about 500 nm and declines to a value of 60% or less of the maximum at an infrared wavelength less than about 1,600 nm.

As noted above, scattering can be defined by transmission haze, which can be measured using a hazemeter or spectrophotometer according to ASTM D1003 or ISO 13468. Measurement of transmission haze is related to measurement of static scattering as two different ways to measure light-scattering of a material. Transmission haze results typically also vary with wavelength of light used to make the measurement. If the wavelength-dependent transmission haze of the polymers with light-scattering particles described herein is measured and plotted, the curve typically has a maximum at a wavelength less than about 600 nm. Thus, in some cases the light-scattering particles described herein dispersed in the polymers described result in maximum transmission haze at a wavelength less than about 600 nm. Such materials also have transmission haze at infrared wavelengths up to about 2,500 nm, such as up to about 1,600 nm, for example from 1,064 nm to 1,600 nm, that is less than 60% of the maximum transmission haze, for example less than 20%, less than 10%, less than 5%, or in some cases less than 1%.

The print material, and the film formed from the print material, will have a positive optical density. The optical density of the print material or the film can be from about 0.5 to 1.0, for example about 0.8. The optical density can depend on the concentration of light-scattering particles in the print material or the film and the optical path length through the print material or the film. In some cases, a polymer film made from the print material described herein to a thickness of about 20 μm has an optical density of 0.7 to 0.9, such as 0.75 to 0.85, for example 0.8.

The polymer matrix is a vinylic polymer such as a styrenic, acrylic, or (meth)acrylic polymer, for example a polyacrylate, polymethacrylate, polystyrene, or polyether. In one case the polymer is polybenzylmethacrylate. The light conditioning component 104 is generally made by forming a precursor mixture having a vinylic monomer, the light-scattering particles described above, and optionally quantum dots. The vinylic monomer is a molecule that, when polymerized, forms a vinylic polymer as described above. The polymers have refractive index in the range of about 1.3 to 1.7.

The polymer materials described herein are generally made from curable precursor materials. The curable precursor materials include curable monomers, oligomers, and/or polymers, for example pre-polymers, that are curable using thermal means and/or exposure to radiation such as UV radiation. Acrylate and styrenic monomers, such as any reasonable variant of styrene and any reasonable (meth)acrylate monomer, can be used. Oligomers and pre-polymers made from such materials can also be used. Examples include methyl (meth)acrylate; ethyl (meth)acrylate); benzyl (meth)acrylate; styrene; methyl styrene; cyclic trimethylolpropane formal (meth)acrylate; alkoxylated tetrahydrofurfuryl (meth)acrylate; phenoxyalkyl (meth)acrylates, such as 2-phenoxyethyl (meth)acrylate and phenoxymethyl (meth)acrylate; 2(2-ethoxyethoxy)ethyl (meth)acrylate. Other suitable di(meth)acrylate monomers include 1,6-hexanediol diacrylate, 1,12 dodecanediol di(meth)acrylate; 1,3-butylene glycol di(meth)acrylate; di(ethylene glycol) methyl ether methacrylate; polyethylene glycol di(meth)acrylate monomers, including ethylene glycol di(meth)acrylate monomers and polyethylene glycol di(meth)acrylate; dicyclopentenyloxyethyl acrylate (DCPOEA), isobornyl acrylate (ISOBA), dicyclopentenyloxyethyl methacrylate (DCPOEMA), isobornyl methacrylate (ISOBMA), and N-octadecyl methacrylate (OctaM), and the like, including holmologs of ISOBA and ISOBMA in which one or more of the methyl groups on the ring is replaced by hydrogen. Properties of the polymer can be tailored as needed by selecting monomers that give desired properties. Mixtures of monomers can also be used. The solids, for example the light-scattering particles, are generally added to the liquid monomer and mixed to disperse. A polymerization initiator is also added. Peroxide, nitrile, and α-functionalized ketone initiators can be used. Examples include AIBN, benzoyl peroxide, and Irgacure® 907. Mixtures of initiators can also be used. The curable precursor mixture can also include cross-linking agents to tailor final properties of the polymer matrix. Polyfunctional acrylates such as pentaerythritol tetraacrylate; pentaerythritol tetramethacrylate; di(trimethylolpropane) tetraacrylate; and di(trimethylolpropane) tetramethacrylate can be used as cross-linkers. Ranges of components, in weight percents, that can be used to make the light conditioning component 104 are as follows:

| | |
|---|---|
| Vinylic monomer | 35-95 |
| Cross-linking agent | 0-10 |
| Initiator | 1-10 |
| Quantum dots | 0-40 |
| Light-scattering particles | 0.1-15. |

Example formulation ranges with specific light-scattering particles are as follows:

| | | |
|---|---|---|
| UV Curable Component | 45-95 | wt % |
| Nominal 200 nm TiO₂ particles | 0.5-15 | wt % |
| Quantum dots | 5-40 | wt % |
| UV Curable Component | 50-94.9 | wt % |
| Nominal 50 nm silver particles | 0.1-10 | wt % |
| Quantum dots | 5-40 | wt % |

Here, the UV curable component can be 83.55 wt % benzyl methacrylate, 6.45 wt % pentaerythritol tetraacrylate, and 10 wt % Irgacure 907, as an example. Specific formulation examples using the two types of light-scattering particles above, along with the UV curable component formulation above, are as follows:

### Formulation 1—

| | | |
|---|---|---|
| UV Curable Component | 70 | wt % |
| Nominal 200 nm TiO₂ particles | 5 | wt % |
| Quantum dots | 25 | wt % |

### Formulation 2—

| | | |
|---|---|---|
| UV Curable Component | 95 | wt % |
| Nominal 200 nm TiO₂ particles | 5 | wt % |

### Formulation 3—

| | | |
|---|---|---|
| UV Curable Component | 74.5 | wt % |
| Nominal 50 nm Ag particles | 0.5 | wt % |
| Quantum dots | 25 | wt % |

### Formulation 4—

| | | |
|---|---|---|
| UV Curable Component | 95.5 | wt % |
| Nominal 50 nm Ag particles | 0.5 | wt % |

Mixtures of different types of light-scattering particles can also be used. For example, mixtures of different types of ceramic particles, or mixtures of ceramics with silver, or mixtures of different particle size range populations can be used. One such formulation is as follows:

### Formulation 5—

| | | |
|---|---|---|
| UV Curable Component | 73.5 | wt % |
| Nominal 200 nm TiO₂ particles | 1 | wt % |
| Nominal 50 nm Ag particles | 0.5 | wt % |
| Quantum dots | 25 | wt % |

Dispersants can be used to maintain dispersion of the scattering particles and the quantum dots in the formulation.

The formulations above are useful in depositions performed by precision printing. In general, a formulation is applied to a substrate using a printer that has one or more nozzles for dispensing a formulation onto the substrate. In order to control the deposition, the formulation is made to have fluid properties in an operative range. In some cases, the formulation is made to have a viscosity less than about 30 cp, for example 10-25 cp. Appropriate solvents can be used to lower viscosity, and curable pre-polymers can be used to increase viscosity in the formulation.

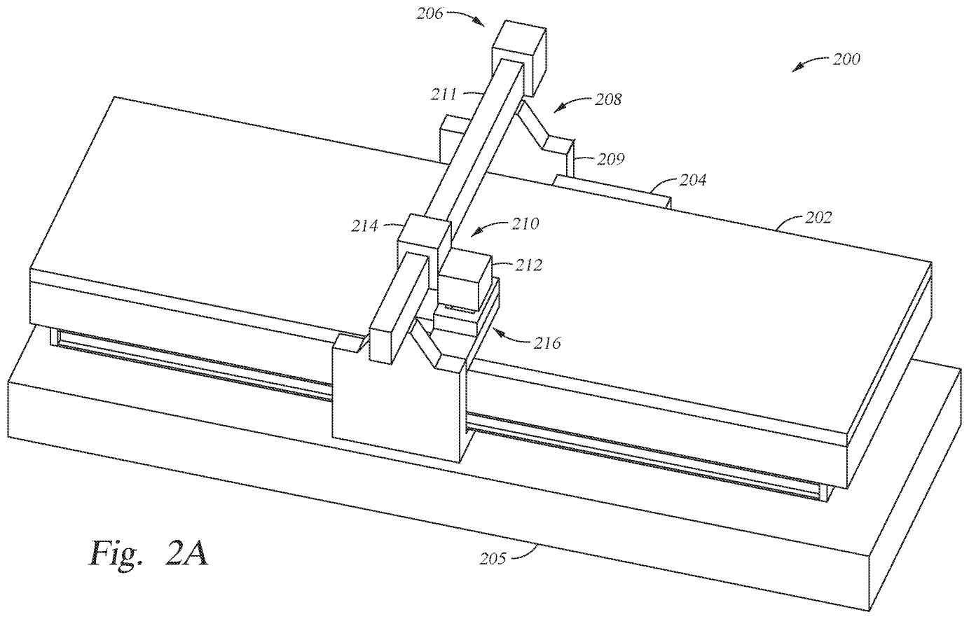

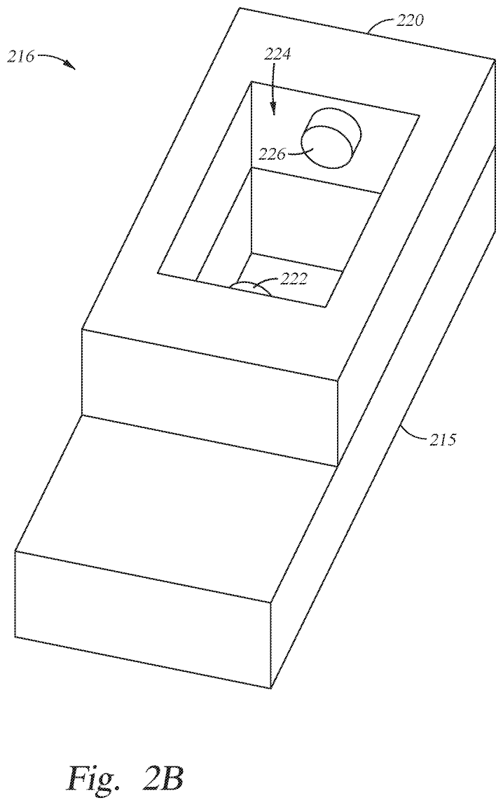

A precision inkjet printer apparatus can be used to deposit the above formulations on a substrate. Such a printer is schematically shown in FIG. 2A, which is an isometric top view of a print apparatus 200 according to one embodiment. The print apparatus 200 has a substrate support 202, a substrate holder 204, and a print assembly 206 disposed in operative juxtaposition with the substrate support 202. The substrate support 202 generally supports a substrate in a manner that allows substantially frictionless motion of the substrate on the substrate support 202 such that different areas of the substrate can be positioned for processing by the print assembly. The substrate holder 204 reversibly attaches to the substrate and moves along the substrate support 202 to position the substrate. The substrate support 202 and the print assembly 206 are positioned on a foundation 205 that stabilizes the print apparatus 200.

The print assembly 206 has a print support 208 and a dispenser assembly 210 coupled to the print support 208. The print support 208 includes two stands 209, one on either side of the substrate support 202 and extending from the foundation 205. A beam 211 extends across the substrate support 202 from one stand 209 to the opposite stand 209. The dispenser assembly 210 moves along the print support 208 across the substrate support 202 to apply print materials to a substrate disposed on the substrate support 202. The dispenser assembly 210 generally includes a dispenser 212 coupled to a carriage 214. The carriage is movably coupled to the print support 208 and moves along the print support 208 by any convenient means of positioning.

The print support 208 also includes a diagnostic module 216 that is used to monitor performance of the dispenser assembly 210. Here, the diagnostic module 216 is located at one end of the print support 208 adjacent to an edge of the substrate support 202 so diagnostics can be performed without impacting the substrate support 202. The diagnostic module 216 is shown attached to one of the stands 209, but the diagnostic module 216 can be located at any convenient location for access by the dispenser assembly 210. The dispenser assembly 210 generally moves to the location for accessing the diagnostic module 216 and interacts with the diagnostic module 216 to perform diagnostics on the dispenser 212.

The dispenser 212 generally includes a plurality of nozzles or openings (not shown) for dispensing print material. Print material is generally dispensed in specific quantities at specific times, forming droplets that traverse to the substrate. The diagnostic module 216 is used to determine, among other things, droplet size (i.e. volume), ejection velocity, and trajectory. The dispenser 212 positions itself in an operative position with respect to the diagnostic module 216, and dispenses print material as the diagnostic module 216 “watches.”

FIG. 2B is a detailed view of the diagnostic module 216 according to one embodiment. The diagnostic module 216 includes a disposal 215 and an analyzer 220. The disposal 216 receives print material dispensed during diagnostic cycles. The analyzer 220 is an optical analyzer that determines volume, velocity, and trajectory of droplets ejected by the dispenser 212 based on optical effects of the droplets. The analyzer 220 includes a laser 222 that emits infrared electromagnetic radiation. The radiation is used to detect a shadow cast by a droplet emitted from the dispenser 212, a reflection of radiation from a droplet emitted from the dispenser 212, or an interference pattern produced by a droplet emitted from the dispenser 212. The laser may be a solid state laser or a semiconductor laser, for example a rare-earth-doped solid state laser (rare earth dopants such as Nd, Yb, Er, Ho, Pm, Tm, and Ce doped, singly or in mixtures, in solid state materials such as glass, YAG, LiSrAlF, LiCaAlF, alexandrite, CaF₂, ZnSe, and the like), another solid state laser like Ti:sapphire, or a laser diode operating from about 1-3 μm in wavelength.

The laser 222 is located in the analyzer 220 such that radiation emitted by the laser 222 is emitted into an opening 224 of the analyzer 220. The radiation traverses the opening 224 to a detector 226, which is shown here located generally opposite from the laser 222 but may be located in any convenient location to detect laser light transmitted or reflected in the opening 224. During a diagnostic cycle, the dispenser assembly 210 moves into alignment with the diagnostic module 216 such that the print nozzles of the dispenser assembly 210 have access to dispense droplets through the opening 224. The laser 222 is activated and droplets are dispensed through the radiation exposure zone in the opening. Laser radiation interacts with one or more droplets in the radiation exposure zone, and the resulting radiation pattern is detected by the detector 226. The detected radiation pattern contains information that is then used to determine size, speed, and trajectory of the droplets.

The materials described above for light-scattering particles are useful in the apparatus above. The materials detailed above used to make a print material have advantages when used in the apparatus described above because scattering of IR radiation is low. Because scattering of IR radiation is low, precise measurement of droplets can be performed using IR laser radiation. The uniform effect of the overall droplet on the incident radiation can still be observed in the IR spectrum without any substantial effect from components of the droplet.

While the foregoing is directed to embodiments of the present invention, other and further embodiments of the present disclosure may be devised without departing from the basic scope thereof, and the scope thereof is determined by the claims that follow.

What is claimed is:

1. A print material, comprising:
a curable precursor mixture; and
a plurality of light-scattering particles, wherein a droplet of the print material having diameter of about 30 μm has a maximum transmission haze at a wavelength less than about 500 nm and a transmission haze at an infrared wavelength up to about 1,600 nm that is less than 60% of the maximum transmission haze.

2. The print material of claim 1, further comprising quantum dots.

3. The print material of claim 2, further comprising a polymerization initiator.

4. The print material of claim 2, wherein the precursor mixture contains at least one vinylic monomer.

5. The print material of claim 1, wherein the light-scattering particles include silver nanoparticles, ceramic nanoparticles, or metal oxide nanoparticles.

6. The print material of claim 5, wherein the light-scattering particles include silver nanoparticles ranging in size from about 30 nm to about 150 nm.

7. The print material of claim 5, wherein the light-scattering particles include TiO₂ nanoparticles ranging in size from about 100 nm to about 350 nm.

8. The print material of claim 6, wherein the one or more quantum dots makes up from about 0 wt % to about 40 wt % of the print material.

9. The print material of claim 6, wherein the silver nanoparticles have an oxide coating with thickness of 2 to 25 nm.

10. The print material of claim 1, wherein the curable precursor mixture, when solidified, has a refractive index of about 1.3 to about 1.7.

11. The print material of claim 1, wherein the transmission haze at an infrared wavelength up to about 1,600 nm is less than 20% of the maximum transmission haze.

12. The print material of claim 1, wherein the transmission haze at an infrared wavelength up to about 1,600 nm is less than 10% of the maximum transmission haze

13. A print material, comprising:
a curable precursor mixture; and
a plurality of light-scattering particles, wherein a polymer film of thickness about 20 μm formed from the print material has a maximum transmission haze at a wavelength less than about 500 nm and a transmission haze at an infrared wavelength up to about 1,600 nm that is less than 60% of the maximum transmission haze.

14. The print material of claim 13, wherein the curable precursor mixture, when solidified, has a refractive index of about 1.3 to about 1.7.

15. The print material of claim 13, wherein the light-scattering particles include silver nanoparticles, ceramic nanoparticles, or metal oxide nanoparticles.

16. The print material of claim 15, wherein the light-scattering particles include silver nanoparticles ranging in size from about 30 nm to about 150 nm.

17. The print material of claim 15, wherein the light-scattering particles include TiO₂ nanoparticles ranging in size from about 100 nm to about 350 nm.

18. The print material of claim 13, wherein the transmission haze at an infrared wavelength up to about 1,600 nm is less than 20% of the maximum transmission haze.

19. The print material of claim 13, wherein the transmission haze at an infrared wavelength up to about 1,600 nm that is less than 10% of the maximum transmission haze

20. A method of making a device, comprising:
applying a print material to a substrate, the print material comprising:
a curable precursor mixture;
one or more quantum dots; and
a plurality of light-scattering particles, wherein a droplet of the print material having a diameter of about 30 μm has a maximum transmission haze at a wavelength less than about 500 nm and a transmission haze at an infrared wavelength up to about 1,600 nm that is less than about 60% of the maximum transmission haze; and
solidifying the print material to form a structure on the substrate.

21. The method of claim 20, wherein the light-scattering particles include silver nanoparticles, ceramic nanoparticles, or metal oxide particles.

22. The method of claim 20, wherein the light-scattering particles include silver nanoparticles ranging in size from about 30 nm to about 150 nm.

23. The method of claim 20, wherein the light-scattering particles include TiO₂ nanoparticles ranging in size from about 100 nm to about 250 nm.

24. The method of claim 20, wherein the one or more quantum dots makes up from about 0 wt % to about 40 wt % of the print material.

25. The method of claim 24, wherein applying the print material to the substrate includes printing the print material on the substrate by an inkjet process, and further comprising measuring characteristics of droplets of the print material using an infrared laser.

26. The method of claim 22, wherein the silver nanoparticles have an oxide coating with thickness of 2 to 25 nm.

27. The method of claim 22, wherein the print material further comprises a polymerization initiator.

28. The method of claim 20, wherein the light-scattering particles include silver nanoparticles and TiO₂ nanoparticles.

29. The method of claim 20, wherein the curable precursor mixture, when solidified, has a refractive index of about 1.3 to about 1.7.

30. The method of claim 20, wherein the transmission haze at an infrared wavelength up to about 1,600 nm is less than 20% of the maximum transmission haze.

31. The method of claim 20, wherein transmission haze at an infrared wavelength up to about 1,600 nm is less than 10% of the maximum transmission haze.

32. A device having a component comprising:
a vinylic polymer; and
a plurality of light-scattering particles dispersed in the polymer, wherein a film of the polymer containing the dispersed light-scattering particles and having a thickness of about 20 μm has a maximum transmission haze at a wavelength less than about 500 nm and a transmission haze at an infrared wavelength up to about 1,600 nm that is less than about 60% of the maximum transmission haze.

33. The device of claim 32, further comprising a plurality of quantum dots.

34. The device of claim 32, wherein the vinylic polymer has a refractive index of about 1.3 to about 1.7.

35. The device of claim 32, wherein transmission haze at an infrared wavelength up to about 1,600 nm is less than 20% of the maximum transmission haze.

36. The device of claim 32, wherein transmission haze at an infrared wavelength up to about 1,600 nm is less than 10% of the maximum transmission haze.

37. An inkjet printer, comprising:
a print assembly juxtaposed with a substrate support; and
a diagnostic module coupled to the print assembly or the substrate support, the diagnostic module comprising an infrared laser operating at a wavelength of 850 nm to 1,600 nm.

38. The inkjet printer of claim 37, wherein the laser operates at a wavelength of 900 nm to 1,100 nm.

39. The inkjet printer of claim 37, wherein the laser operates at a wavelength of 1,064 nm, 1,370 nm, 1,540, nm, or 1,550 nm.

40. A method of making a device, comprising:
applying a print material to a substrate, the print material comprising:
a curable precursor mixture;
one or more quantum dots; and
a plurality of light-scattering particles, wherein a polymer film formed from the print material to a thickness of about 20 μm has a maximum transmission haze at a wavelength less than about 500 nm and a transmission haze at an infrared wavelength up to about 1,600 nm that is less than about 60% of the maximum transmission haze; and
solidifying the print material to form a structure on the substrate.
